(19) United States
(12) Patent Application Publication
(10) Pub. No.: US 2014/0005344 A1
(43) Pub. Date: Jan. 2, 2014

(54) HARDENER FOR EPOXY RESIN SYSTEMS AND USE THEREOF

(71) Applicants: Stefanie RINKER, Huenxe (DE); Franz-Albert von ITTER, Alfter (DE); Bettina BRESSEL, Marl (DE); Benjamin WILLY, Duesseldorf (DE); Manfred NEUMANN, Marl (DE); Chris JONES, Muehlheim (DE); Jeffrey H. DIMMIT, Joplin, MO (US)

(72) Inventors: Stefanie RINKER, Huenxe (DE); Franz-Albert von ITTER, Alfter (DE); Bettina BRESSEL, Marl (DE); Benjamin WILLY, Duesseldorf (DE); Manfred NEUMANN, Marl (DE); Chris JONES, Muehlheim (DE); Jeffrey H. DIMMIT, Joplin, MO (US)

(73) Assignee: Evonik Industries AG, Essen (DE)

(21) Appl. No.: 13/926,267

(22) Filed: Jun. 25, 2013

(30) Foreign Application Priority Data
Jun. 29, 2012 (DE) 10 2012 211 323.1

(51) Int. Cl. C08G 59/42

(52) U.S. Cl. CPC C08G 59/4284
USPC 525/523; 252/183.11

(57) ABSTRACT

A hardener system for epoxy resins comprising i) at least one aromatic dianhydride compound A having a melting point of at least 35° C., ii) at least one monoanhydride compound B having a melting point of not more than 30° C. and iii) at least one catalyst C, is provided. The aromatic dianhydride compound A is dispersed in the hardener system. The present invention further provides for the use of said hardener systems and to processes for hardening epoxy resin systems.

### CROSS REFERENCE TO RELATED APPLICATIONS

This application claims priority to German Application No. 102012211323.1, filed Jun. 29, 2012, the disclosure of which is incorporated herein by reference in its entirety.

### BACKGROUND OF THE INVENTION

The present invention relates to a hardener system for epoxy resins comprising i) at least one aromatic dianhydride compound A having a melting point of at least 35° C., ii) at least one monoanhydride compound B having a melting point of not more than 30° C. and iii) at least one catalyst C, the aromatic dianhydride compound A being dispersed in the hardener system. The present invention further provides for the use of said hardener systems and to processes for hardening epoxy resin systems.

Epoxy resins are one of the most versatile polymeric materials. They find uses, for example, as coatings, adhesives, casting resin compounds, moulding compounds, as embedding compounds for encasing electronic components, as laminates and base material for printed circuits, and as matrix resins for fibre-reinforced plastics.

The conversion of monomeric or oligomeric epoxy resins to polymeric materials requires co-reactants, which are referred to as hardeners or hardening agents. According to the type of hardener, the hardening reaction is effected at temperatures around room temperature or low temperatures (called “cold hardening”) or at elevated temperatures (called “warm or hot hardening”). For hardening of epoxy resins at low temperatures for industrial applications, predominantly aliphatic primary or secondary amines and polyamines are used. Polythiols or specific salts are less commonly used.

All unmodified amines are alkaline to strongly alkaline. Liquid amines, especially the aliphatic and cycloaliphatic amines, may cause skin damage to the extent of chemical burns. Another disadvantage of conventional amines is the high volatility of the liquid amines. A great disadvantage of the cold curing of epoxy resins with the abovementioned hardening agents is the low thermal and chemical stability of the products which form. Increasing the thermal, solvent and chemical stability is conventionally accomplished by hardening of epoxy resins at elevated temperatures in a hot hardening operation with aromatic or cycloaliphatic amines, carboxylic anhydrides or polyphenols, or with latent hardeners.

However, there is a demand for epoxy resin hardener systems which can harden at minimum temperature and give rise to products having increased thermal, chemical and solvent stability. Potential applications for these are, for example, adhesives, matrix resins for fibre composite materials and repair resins for components where the use of high temperatures is not an option. Further applications are casting resin and embedding compounds, specifically for encasing large electronic components where the curing can proceed at low temperature, with low exothermicity and consequently with a considerable energy saving, a further advantage being that products having reduced internal tension arise.

It is conventionally known that the curing of epoxy resins, especially in the case of bisphenol A resins, with cyclic dicarboxylic anhydrides and tetracarboxylic bisanhydrides, entails hardening temperatures of at least 120-150° C., in which case hardening times of several hours may still be required; see Houben-Weyl, Methoden der Organischen Chemie [Methods of Organic Chemistry], Volume E20, Makromolekulare Stoffe [Macromolecular Materials], Georg Thieme Verlag Stuttgart, 1987, page 1959. Even at these temperatures, the crosslinking reaction is still so slow that it is generally not possible to dispense with the use of accelerators. It is advantageous, however, that the hardening with anhydrides proceeds with lower exothermicity compared to hardening with amines. The hardened products have good electrical insulation properties and good thermal stability.

Applicants are aware of only one example of the hardening of epoxy resins with cyclic acid anhydrides at low temperatures as indicated in U.S. Pat. No. 4,002,599. However, only systems based on polyglycidyl-substituted aminophenols are described.

DE 2837726 describes epoxy resin compositions composed of at least one epoxy resin and a hardening agent, the hardening agent comprising 2,3,3′,4″-diphenyltetracarboxylic anhydride. According to DE 2837726, the dianhydride first has to be dissolved before hardening can be effected; in some cases, the mixture is even cooled again. This can lead to problems; more particularly, the hardening agent can separate out.

The problem addressed by the present invention is that of providing improved hardener systems for the hardening of epoxy resins. These hardeners should be easy to process and, after hardening, should lead to resin systems having good, long-lasting heat distortion resistance. More particularly, it is to be possible to dispense with the addition of solvents for incorporation of the hardeners.

### SUMMARY OF THE INVENTION

These and other objects have been achieved according to the present invention, the first embodiment of which includes a composition, comprising:

i) an aromatic dianhydride compound A having a melting point of at least 35° C.;

ii) a monoanhydride compound B having a melting point of not more than 30° C.; and

iii) a catalyst C;

wherein

the aromatic dianhydride compound A is dispersed in the composition, and

the composition is a hardener system for an epoxy resin.

In another embodiment the present invention provides a process to harden an epoxy resin system, comprising:

mixing the composition according to the first embodiment with the epoxy resin system; and curing the mixture at a temperature of at least 25° C. to obtain a hardened epoxy resin. According to the invention the curing temperature is less than a melting temperature of the aromatic dianhydride compound A.

### DETAILED DESCRIPTION OF THE PREFERRED EMBODIMENTS

The hardener systems according to the present invention satisfy the complex profile of requirements. The present invention thus provides hardener systems for epoxy resins comprising i) at least one aromatic dianhydride compound A having a melting point of at least 35° C., ii) at least one monoanhydride compound B having a melting point of not more than 30° C. and iii) at least one catalyst C, the aromatic dianhydride compound A being dispersed in the hardener system.

The hardener mixture according to the present invention, may additionally include further additives, for example lubricants, antiblocking agents, release agents, stabilizers, for example antioxidants, light stabilizers, heat stabilizers or foam stabilizers, antistats, conductive additives, flame retardants, pigments, impact modifiers, flexibilizers, plasticizers, adhesion promoters, fillers, for example carbon black, calcium carbonate, talc, silicates, cotton flocks, synthetic polymers, metal powder, graphite or glass fibres, reinforcing materials, blowing agents, kickers, nucleating agents, antibacterial agents or fungicides. The additives mentioned which can be used in the process according to the invention include all substances known as suitable additives to the person skilled in the art for production of epoxy resin systems.

The hardener systems according to the present invention may be particularly suitable for use in epoxy resins. For instance, the components required for the hardening are already present entirely in the hardener system; the addition of further additives on user hardening is unnecessary. In addition, more particularly, inexpensive and commercially available aromatic dianhydrides, for example 5,5′-carbonylbis(isobenzofuran-1,3-dione) (s-BTDA), may be used. This is surprising since the aromatic dianhydrides A are solids having a high melting point. These solids are conventionally considered to be incorporable into the resin system only with extreme difficulty. For instance, according to DE 2837726, DE 2256277, or U.S. Pat. No. 3,989,573, homogeneous processing of the dianhydrides is possible only at temperatures above the melting point thereof or through addition of solvents, or with specific epoxy resins. In the context of the present invention, it has been found that, surprisingly, in the case of the hardener systems according to the present invention, neither the addition of solvents nor homogeneous distribution by melting is required. The hardening of the epoxy resins admixed with the inventive hardener system may also, contrary to conventional systems, be effected below the melting temperature of the aromatic dianhydrides used. In fact, the hardener system according to the present invention allows simple processing at room temperature without addition of solvent. In addition, the hardening may be effected at low temperatures. The hardened resin systems according to the present invention exhibit high heat distortion resistance, even at temperatures above 200° C. The hardened resin systems are homogeneous; more particularly, no settling out of individual components and no cracking is observed.

A particular advantage of the hardener system according to the present invention may be the ease of handling thereof. This results from the fact that the system is in the form of a dispersion and does not require any further addition of solvent. In corresponding curing operations, the hardened systems have high glass transition temperatures and high heat distortion resistance.

The hardener system according to the present invention features a combination of i) at least one aromatic dianhydride compound A having a melting point of at least 35° C., ii) at least one monoanhydride compound B having a melting point of not more than 30° C. and iii) at least one catalyst C, the aromatic dianhydride compound A being dispersed in the hardener system.

Suitable hardeners in the context of the dianhydride compound A are cyclic anhydrides of aromatic, aliphatic, cycloaliphatic and heterocyclic polycarboxylic acids. The aromatic carboxylic anhydrides may contain additional functional groups.

Examples of aromatic, aliphatic and cycloaliphatic dianhydride compounds A include benzo[1,2-c:4,5-c′]difuran-1,3,5,7-tetraone (PMDA), benzo[1,2-c:3,4-c′]difuran-1,3,6,8-tetraone, [4,4′-biisobenzofuran]-1,1′,3,3′-tetraone (a-BPDA), [4,5′-biisobenzofuran]-1,1′,3,3′-tetraone (s BPDA), [5,5′-biisobenzofuran]-1,1′,3,3′-tetraone, 5,5′ methylenebis(isobenzofuran-1,3-dione), 4-((1,3-dioxo-1,3-dihydroisobenzofuran-5-yl)methyl)isobenzofuran-1,3-dione, 4,4′-methylenebis(isobenzofuran-1,3-dione), 5,5′-(propane-2,2-diyl)bis(isobenzofuran-1,3-dione), 4 (2-(1,3-dioxo-1,3-dihydroisobenzofuran-5-yl)propan-2-yl)isobenzofuran-1,3-dione, 4,4′-(propane-2,2-diyl)bis(isobenzofuran-1,3-dione), 5,5′-(perfluoropropane-2,2-diyl)bis(isobenzofuran-1,3-dione) (6FDA), 5,5′-carbonylbis(isobenzofuran-1,3-dione) (s-BTDA), 4-(1,3-dioxo-1,3-dihydroisobenzofuran-5-carbonyl)isobenzofuran-1,3-dione (a-BTDA), 4,4′-carbonylbis(isobenzofuran-1,3-dione), 5,5′-oxybis(isobenzofuran-1,3-dione) (OPDA), 4-((1,3-dioxo-1,3-dihydroisobenzofuran-5-yl)oxy)isobenzofuran-1,3-dione, 4,4′-oxybis(isobenzofuran-1,3-dione), 5,5′-sulphonylbis(isobenzofuran-1,3-dione) (DSDA), 5,5′((propane-2,2-diylbis(4,1-phenylene))bis(oxy))bis(isobenzofuran-1,3-dione).

Apart from the anhydrides already described, for example, aromatic carboxylic anhydrides having fused ring systems may also be suitable, especially 1H-cyclopenta[6,7]naphtho[2,3-c]furan-1,3,6,8(7H)-tetraone, naphtho[1,2-c:5,6-c′]difuran-1,3,6,8-tetraone, naphtho[1,2-c:6,7-c′]difuran-1,3,7,9-tetraone, isochromeno[6,5,4-def]isochromene-1,3,6,8-tetraone (NTCDA), anthra[2,1,9-def:6,5,10-d′e′f′]diisochromene-1,3,8,10(3aH,12H)-tetraone and the halogen and nitro derivatives thereof.

Heterocyclic carboxylic anhydrides which may be used in accordance with the invention include, for example, difuro[3,4-b:3′,4′-e]pyrazine-1,3,5,7-tetraone, thieno[2,3-c:4,5-c′]difuran-1,3,5,7-tetraone or difuro[3,4-b:3′,4′-d]furan-1,3,5,7-tetraone.

The aromatic dianhydride compound A may preferably be selected from benzo[1,2-c:4,5-c′]difuran-1,3,5,7-tetraone (PMDA), [4,4′-biisobenzofuran]-1,1′,3,3′-tetraone (a-BPDA), [4,5′-biisobenzofuran]-1,1′,3,3′-tetraone (s-BPDA), 5,5′-(perfluoropropane-2,2-diyl)bis(isobenzofuran-1,3-dione) (6FDA), 5,5′-carbonylbis(isobenzofuran-1,3-dione) (s-BTDA), 4-(1,3-dioxo-1,3-dihydroisobenzofuran-5-carbonyl)isobenzofuran-1,3-dione (a-BTDA), 5,5′-oxybis(isobenzofuran-1,3-dione) (OPDA), 5,5′-sulphonylbis(isobenzofuran-1,3-dione) (DSDA), isochromeno[6,5,4-def]isochromene-1,3,6,8-tetraone (NTCDA) and/or substituted derivatives thereof.

Aromatic dianhydride compounds A suitable according to the present invention are shown in Table 1, specifying the abbreviations previously used and the chemical structural formula thereof

TABLE 1

| Abbreviation | Structure |
|---|---|
| s-BTDA | 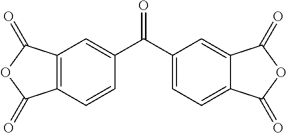 [SMILES: O=C(c1ccc2c(c1)C(=O)OC2=O)c1ccc2c(c1)C(=O)OC2=O] |
| s-BPDA | 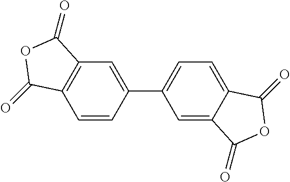 [SMILES: O=C1OC(=O)c2cc(-c3ccc4c(c3)C(=O)OC4=O)ccc21] |
| OPDA | 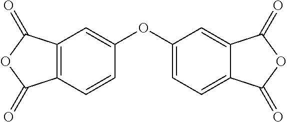 [SMILES: O=C1OC(=O)c2cc(Oc3ccc4c(c3)C(=O)OC4=O)ccc21] |
| 6FDA | 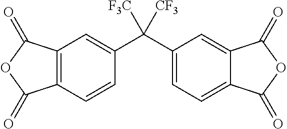 [SMILES: O=C1OC(=O)c2cc(C(c3ccc4c(c3)C(=O)OC4=O)(C(F)(F)F)C(F)(F)F)ccc21] |
| PMDA | 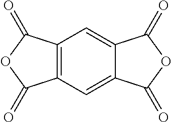 [SMILES: O=c1oc(=O)c2cc3c(=O)oc(=O)c3cc12] |
| a-BTDA | 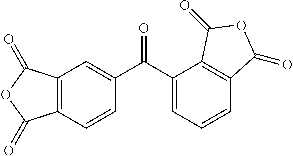 [SMILES: O=C1OC(=O)c2cc(C(=O)c3cccc4c3C(=O)OC4=O)ccc21] |
| a-BPDA | 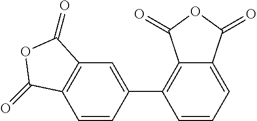 [SMILES: O=C1OC(=O)c2cc(-c3cccc4c3C(=O)OC4=O)ccc21] |
| DSDA | 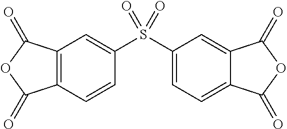 [SMILES: O=C1OC(=O)c2cc(S(=O)(=O)c3ccc4c(c3)C(=O)OC4=O)ccc21] |
| NTCDA | 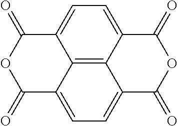 [SMILES: O=C1OC(=O)c2ccc3c4c(ccc1c24)C(=O)OC3=O] |

In preferred embodiments according to the present invention, the aromatic dianhydride compound A is selected from 5,5′-carbonylbis(isobenzofuran-1,3-dione) (s-BTDA), and/or benzo[1,2-c:4,5-c′]difuran-1,3,5,7-tetraone (PMDA).

These aromatic dianhydride compounds A have a melting point of at least 35° C., preferably of at least 100° C. and especially preferably of at least 180° C., and therefore, they may be dispersed in the hardener system in solid form at room temperature.

The mean particle size of the aromatic dianhydride compounds A used, i.e. the mean diameter of the particles, may preferably be less than 100 μm, especially preferably less than 10 μm. The mean particle size may be determined with the aid of light scattering. In this context, a particle size distribution according to DIN EN ISO 8130-13 is employed.

The proportion of the aromatic dianhydride compounds A in the inventive hardener system may be 0.5 to 80% by weight, preferably 1 to 60% by weight and most preferably 5 to 50% by weight.

A further essential component of the hardener system according to the present invention is the at least one monoanhydride compound B having a melting point of not more than 30° C., preferably of not more than 25° C. and especially preferably of not more than 20° C.

The monoanhydride compound B used in accordance with the invention may be selected from the group comprising cyclic anhydrides of aromatic, aliphatic, cycloaliphatic and heterocyclic polycarboxylic acids. The carboxylic anhydrides may contain additional functional groups. Examples of monoanhydride compounds B include methylhexahydroisobenzofuran-1,3-dione (MHHPSA), either as a pure substance or as an isomer mixture, 5-methyl-3a,4,7,7a-tetrahydro-4,7-methanoisobenzofuran-1,3-dione (MNA), 3-methylfuran-2,5-dione, 3,3,4,4,5,5-hexafluorodihydro-2H-pyran-2,6(3H)-dione and/or 3,3-dimethyldihydrofuran-2,5-dione, very particular preference being given to methylhexahydroisobenzofuran-1,3-dione (MHHPSA) and/or 5-methyl-3a,4,7,7a-tetrahydro-4,7-methanoisobenzofuran-1,3-dione (MNA).

In an alternative embodiment of the present invention, the monoanhydride compound B may be selected from methylhexahydroisobenzofuran-1,3-dione (MHHPSA), 5-methyl-3a,4,7,7a-tetrahydro-4,7-methanoisobenzofuran-1,3-dione (MNA), 5-methyl-3a,4,7,7a tetrahydroisobenzofuran-1,3-dione (MTHPA), 3-methylfuran-2,5-dione, 3,3,4,4,5,5-hexafluorodihydro-2H-pyran-2,6(3H)-dione and/or 3,3-dimethyldihydrofuran-2,5-dion; preferably 5-methyl-3a,4,7,7a-tetrahydro-4,7-methanoisobenzofuran-1,3-dione (MNA), 5-methyl-3a,4,7,7a-tetrahydroisobenzofuran-1,3-dione (MTHPA), 3-methylfuran-2,5-dione, 3,3,4,4,5,5-hexafluorodihydro-2H-pyran-2,6(3H)-dione and/or 3,3-dimethyldihydrofuran-2,5-dion; more preferably 5-methyl-3a,4,7,7a-tetrahydro-4,7-methanoisobenzofuran-1,3-dione (MNA) and/or 5-methyl-3a,4,7,7a-tetrahydroisobenzofuran-1,3-dione (MTHPA); even more preferably 5-methyl-3a,4,7,7a-tetrahydroisobenzofuran-1,3-dione (MTHPA) or 5-methyl-3a,4,7,7a-tetrahydro-4,7-methanoisobenzofuran-1,3-dione (MNA); most preferably 5-methyl-3a,4,7,7a-tetrahydroisobenzofuran-1,3-dione (MTHPA).

MTHPA has the following structure:

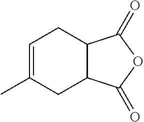

Maleic anhydride, which is conventionally used, as described, for example, in EP 1091992, is unsuitable as monoanhydride compound B in the context of the present invention, since the melting point of maleic anhydride is above 30° C.

The proportion of the monoanhydride compound B in the hardener system according to the present invention may be 20 to 99% by weight, preferably 40 to 99% by weight and most preferably 50 to 95% by weight.

In addition, the inventive hardener system according to the present invention contains at least one catalyst C. The catalyst C may preferably be selected from conventionally known amines, cycloaliphatic or aromatic N-heterocycles, or phenolic amines and/or metal salts.

Examples of amines include: N1,N1-dimethylpropane-1,3-diamine (DMAPA), N1,N1,N3,N3-tetramethylpropane-1,3-diamine, N1,N1,N2,N2-tetramethylethane-1,2-diamine, N,N-dimethyl-1-benzylamine, N,N-diethyl-1-benzylamine, triethylamine, tripropylamine, diisopropylethylamine, 2-dimethylaminoethanol and/or 2-diethyl-aminoethanol.

Cycloaliphatic or aromatic N-heterocycles which may be used in accordance with the invention include, for example, pyrrolidine, piperidine, 1-benzylpiperidine, piperazine, 1,4-dimethylpiperazine, 2,2,6,6-tetramethylpiperidine, 2,2,6,6-tetramethylpiperidine-4-amine, N alkyl-2,2,6,6-tetramethylpiperidine-4-amine, N1,N1-dimethyl-N-3-(2,2,6,6-tetramethylpiperidin-4-yl)propane-1,3-diamine, 2,2,6,6-tetramethylpiperidin-4-ol, 1,2,2,6,6-pentamethylpiperidin-4-ol, 4-alkoxy-2,2,6,6-tetramethylpiperidine, N1,N6-bis(2,2,6,6-tetramethylpiperidin-4-yl)hexane-1,6-diamine, 1H-pyrrole, 1H-imidazole, 1-methyl-1H-imidazole (1MZ), 3-(2-ethyl-4-methyl-1H-imidazol-1-yl)propanenitrile (2E4MZ-CN), 2-ethyl-4-methyl-1H-imidazole (2E4MZ), 2-methyl-1H-imidazole (2MZ), 2-phenyl-1H-imidazole (2PZ), 1-benzyl-2-methyl-1H-imidazole (1B2MZ), 1-benzyl-2-phenyl-1H-imidazole (1B2PZ), (4-methyl-2-phenyl-1H-imidazol-5-yl)methanol (2P4MHZ), (2 phenyl-1H-imidazole-4,5-diyl)dimethanol (2PHZ), 6-(2-(2-methyl-1H-imidazol-1-yl)ethyl)-1,3,5-triazine-2,4-diamine (2MZ-A), 2,3-dihydro-1H-benzo[d]pyrrolo[1,2-a]imidazole (TBZ), 1,3-dialkyl-1H-imidazol-3-ium salts, especially carboxylates, halides, sulphonates, nitrates, sulphates or hydrogensulphates, pyridine, 2-methylpyridine, 3-methylpyridine, 4-methylpyridine and/or 2,6-dimethylpyridine.

Suitable representatives of the phenolic amines include 4-dimethylaminomethylphenol, 2,6-di-tert-butyl-4-dimethylaminomethylphenol (Ionol® 103), 2,4,6-trisdimethylaminomethylphenol and/or 2,4-bisdimethylaminomethyl-6-methylphenol.

Examples of metal salts include zinc(II) acetylacetonate, (1-methylimidazolium)zinc(II) acetylacetonate ((1MZ)Zn(acac)₂), bis(1-methylimidazolium)iron(II) acetylacetonate ((1MZ)₂(Fe(acac)₂), tin octanoate and/or boron trifluoride complexes, for example etherates or complexes with ethylamine.

More preferably, the catalyst C may be selected from N,N-dimethyl-1-benzylamine, N1,N1-dimethyl-N3-(2,2,6,6-tetramethylpiperidin-4-yl)propane-1,3-diamine, 1,2,2,6,6-pentamethylpiperidin-4-ol, 2-ethyl-4-methyl-1H-imidazole (2E4MZ), 1-methyl-1H-imidazole (1MZ), 2-phenyl-1H-imidazole (2PZ), (4-methyl-2-phenyl-1H-imidazol-5-yl)methanol (2P4MHZ), (2-phenyl-1H-imidazole-4,5-diyl)dimethanol (2PHZ), 1,3-dialkyl-1H-imidazol-3-ium salts, especially propanoates or methanesulphonates, 2,6-di-tert-butyl-4-dimethylaminomethylphenol (Ionol® 103) and/or (1 methylimidazolium)zinc(II) acetylacetonate ((1MZ)Zn(acac)₂).

Most preferably, the catalyst C may be selected from N,N-dimethyl-1-benzylamine, 1-methyl-1H-imidazole (1MZ), (4-methyl-2-phenyl-1H-imidazol-5-yl)methanol (2P4MHZ), (2-phenyl-1H-imidazole-4,5-diyl)dimethanol (2PHZ), 1,3-dialkyl-1H-imidazol-3-ium salts, especially propanoates or methanesulphonates, 2,6-di-tert-butyl-4-dimethylaminomethylphenol (Ionol® 103) and/or (1-methylimidazolium)zinc(II) acetylacetonate ((1MZ)Zn(acac)₂).

The proportion of catalyst C in the inventive hardener system may be 0.001 to 5.0% by weight, preferably 0.01 to 3.0% by weight and most preferably 0.1 to 2.0% by weight. It is unimportant whether the catalyst C used is in solid or liquid form.

In one embodiment, the hardener system according to the present invention has the following composition:

i) 5 to 50% by weight of 5,5′-carbonylbis(isobenzofuran-1,3-dione) (s-BTDA), and/or benzo[1,2-c:4,5-c′]difuran-1,3,5,7-tetraone (PMDA), ii) 50 to 95% by weight of methylhexahydroisobenzofuran-1,3-dione (MHHPSA) and/or 5 methyl-3a,4,7,7a-tetrahydro-4,7-methanoisobenzofuran-1,3-dione (MNA), iii) 0.1 to 2.0% by weight of N,N-dimethyl-1-benzylamine, 1-methyl-1H-imidazole (1MZ), (4 methyl-2-phenyl-1H-imidazol-5-yl)methanol (2P4MHZ), (2-phenyl-1H-imidazole-4,5-diyl)dimethanol (2PHZ), 1,3-dialkyl-1H-imidazol-3-ium salts, especially propanoate or methanesulphonate, 2,6-di-tert-butyl-4-dimethylaminomethylphenol (Ionol® 103) and/or (1 methylimidazolium)zinc(II) acetylacetonate ((1MZ)Zn(acac)₂).

In another embodiment, a hardener system according to the present invention may have the following composition:

i) 5 to 50% by weight of 5,5′-carbonylbis(isobenzofuran-1,3-dione) (s-BTDA), and/or benzo[1,2-c:4,5-c′]difuran-1,3,5,7-tetraone (PMDA), ii) 50 to 95% by weight of methylhexahydroisobenzofuran-1,3-dione (MHHPSA), 5-methyl-3a,4,7,7a-tetrahydro-4,7-methanoisobenzofuran-1,3-dione (MNA) and/or 5-methyl-3a,4,7,7a-tetrahydroisobenzofuran-1,3-dione (MTHPA), iii) 0.1 to 2.0% by weight of N,N-dimethyl-1-benzylamine, 1-methyl-1H-imidazole (1MZ), (4 methyl-2-phenyl-1H-imidazol-5-yl)methanol (2P4MHZ), (2-phenyl-1H-imidazole-4,5-diyl)dimethanol (2PHZ), 1,3-dialkyl-1H-imidazol-3-ium salts, especially propanoate or methanesulphonate, 2,6-di-tert-butyl-4-dimethylaminomethylphenol (Ionol® 103) and/or (1 methylimidazolium)zinc(II) acetylacetonate ((1MZ)Zn(acac)₂).

The present invention likewise provides for the use of hardener systems according to the present invention for hardening of epoxy resin systems. The present invention further provides epoxy resin systems comprising at least one epoxy resin and at least one hardener system according to the present invention. The inventive hardener system has the advantage that it can be incorporated as such into the epoxy resins without any requirement for addition of further auxiliaries, especially solvents. Preferably, the inventive epoxy resin system is free of any solvents. A further advantage of the present invention lies in the possibility of achieving hardening below the melting points of the dianhydride compound A, for example at less than 180° C., and at the same time, given selection of suitable hardening cycles, arriving at hardened, heat distortion-stable systems having a high glass transition temperature, especially above 200° C.

In principle, there are no restrictions with regards to the epoxy resins to be used, and mixtures of different epoxy resins may also be present. Preferably, at least one epoxy resin having at least two epoxy groups per monomer is present. This epoxy resin having at least two epoxy groups per monomer may be used alone or in a mixture with further epoxy resins.

Preferably, no aminic epoxy resins, as described, for example, in EP 0181337, or EP 1091992, are present in the inventive epoxy resin system.

Examples of suitable epoxy resins include epoxy resins of the glycidyl ether type which can be synthesized from bisphenol A and epihalohydrins; epoxy resins of the glycidyl ester type which can be synthesized from phthalic acid and epihalohydrins; alicyclic epoxy resins which can be obtained by epoxidation of alicyclic dienes such as cyclopentadiene or cyclohexadiene; epoxidation products of unsaturated polymers such as polybutadiene and polyisoprene; and polymers or copolymers of unsaturated monoepoxides such as glycidyl methacrylate or allyl glycidyl ether. This enumeration is merely descriptive. For example, it is possible to use various polyhydric phenols in place of bisphenol A, or to use other polybasic acids in place of phthalic acid.

The proportion of the hardener system in the mixture with the epoxy resins is generally calculated according to the ratio of the number of anhydride groups in the hardener system to the number of epoxy groups in the epoxy resins used. For every mole of epoxy group present in the epoxy resin used, 0.3-1 mol, more preferably 0.5-0.8 mol and most preferably 0.55-0.75 mol of anhydride groups may be used.

In the case of a process for hardening an epoxy resin according to the present invention, multiple equivalent embodiments may be described.

In one embodiment of the present invention, the above-described hardener system of at least one aromatic dianhydride compound A having a melting point of at least 35° C., at least one monoanhydride compound B having a melting point of not more than 30° C. and at least one catalyst C is first produced and then mixed with at least one epoxy resin. A significant advantage of this embodiment is that the user merely has to combine the epoxy resin and the hardener system on use in the manner of a two-component system. Separate storage of the individual components of the hardener system is unnecessary, which leads to simplification of usability.

In a further embodiment of the present invention, there may at first merely be a mixture of the at least one epoxy resin with a mixture of at least one aromatic dianhydride compound A having a melting point of at least 35° C. and at least one monoanhydride compound B having a melting point of not more than 30° C., to which the at least one catalyst C is then added separately. Overall, in that case, after addition of the catalyst C, the inventive combination of the hardener system comprising i) at least one aromatic dianhydride compound A having a melting point of at least 35° C., ii) at least one monoanhydride compound B having a melting point of not more than 30° C. and iii) at least one catalyst C is again likewise present in the epoxy resin system. In this case, the aromatic dianhydride compound A having a melting point of at least 35° C. is dispersed in the overall system. For this purpose, the at least one aromatic dianhydride compound A having a melting point of at least 35° C. is first mixed with at least one monoanhydride compound B having a melting point of not more than 30° C., such that the dianhydride compound A is dispersed in the monoanhydride compound B. This dispersion may then be added to the at least one epoxy resin. For the actual hardening operation, the at least one catalyst C is then added and the hardening is carried out. For the achievement of the advantage essential to the invention, it is important merely that the inventive epoxy resin is present in the course of the actual hardening of the epoxy resin. The user is thus given the opportunity to use the advantages of the inventive hardener system, but at the same time additionally to gain freedom with regard to the sequence of addition of the individual components.

Thus, the present invention likewise provides processes for hardening epoxy resin systems, wherein a mixture of at least one aromatic dianhydride compound A having a melting point of at least 35° C. and at least one monoanhydride compound B having a melting point of not more than 30° C. is mixed with at least one epoxy resin in a first stage, the aromatic dianhydride compound A being dispersed in the monoanhydride compound B, at least one catalyst C is added in a second stage and then the at least one epoxy resin is cured at a temperature of at least 25° C.

The present invention further provides processes for curing epoxy resin systems, wherein a mixture of at least one aromatic dianhydride compound A having a melting point of at least 35° C., at least one monoanhydride compound B having a melting point of not more than 30° C. and at least one catalyst C, the aromatic dianhydride compound A being dispersed in the hardener system, is mixed with at least one epoxy resin in a first operation and then the at least one epoxy resin is cured at a temperature of at least 25° C.

In the process according to the invention for hardening epoxy resin systems, the hardening may be effected at a temperature of at least 25° C., especially at a temperature of at least 50° C., and the hardening is most preferably effected at a temperature below the melting temperature of the aromatic dianhydride compound A, especially at a temperature of not more than 200° C., especially of not more than 180° C.

The present invention thus encompasses, among others, the following embodiments reproduced hereinafter as points 1 to 16:

Point 1: Hardener systems for epoxy resins comprising i) at least one aromatic dianhydride compound A having a melting point of at least 35° C., ii) at least one monoanhydride compound B having a melting point of not more than 30° C. and iii) at least one catalyst C, the aromatic dianhydride compound A being dispersed in the hardener system.

Point 2: Hardener system according to point 1, wherein the aromatic dianhydride compound A is selected from benzo[1,2-c:4,5-c′]difuran-1,3,5,7-tetraone, [4,4′-biisobenzofuran]-1,1′,3,3′-tetraone, [4,5′-biisobenzofuran]-1,1′,3,3′-tetraone, 5,5′(perfluoropropane-2,2-diyl)bis(isobenzofuran-1,3-dione), 5,5′ carbonylbis(isobenzofuran-1,3-dione), 4-(1,3-dioxo-1,3-dihydroisobenzofuran-5-carbonyl)isobenzofuran-1,3-dione, 5,5′-oxybis(isobenzofuran-1,3-dione), 5,5′-sulphonylbis(isobenzofuran-1,3-dione), isochromeno[6,5,4-def]isochromene-1,3,6,8-tetraone and/or substituted derivatives thereof.

Point 3: Hardener system according to point 1 or 2, wherein the aromatic dianhydride compound A is selected from 5,5′ carbonylbis(isobenzofuran-1,3-dione), and/or benzo[1,2-c:4,5-c′]difuran-1,3,5,7-tetraone.

Point 4: Hardener system according to one or more of points 1 to 3, wherein the monoanhydride compound B is especially selected from the group comprising cyclic anhydrides of aromatic, aliphatic, cycloaliphatic and heterocyclic polycarboxylic acids.

Point 5: Hardener system according to one or more of points 1 to 4, wherein the monoanhydride compound B is selected from methylhexahydroisobenzofuran-1,3-dione, 5-methyl-3a,4,7,7a-tetrahydro-4,7-methanoisobenzofuran-1,3-dione, 3-methylfuran-2,5-dione, 3,3,4,4,5,5-hexafluorodihydro-2H-pyran-2,6(3H)-dione and/or 3,3-dimethyldihydrofuran-2,5-dione.

Point 6: Hardener system according to one or more of points 1 to 5, wherein the catalyst C is selected from amines, cycloaliphatic or aromatic N-heterocycles or phenolic amines and/or metal salts.

Point 7: Hardener system according to one or more of points 1 to 6, wherein the catalyst C is selected from N,N-dimethyl-1-benzylamine, N1,N1-dimethyl-N-3-(2,2,6,6-tetramethylpiperidin-4-yl)propane-1,3-diamine, 1,2,2,6,6-pentamethylpiperidin-4-ol, 2-ethyl-4-methyl-1H-imidazole, 1-methyl-1H-imidazole, 2-phenyl-1H-imidazole, (4-methyl-2-phenyl-1H-imidazol-5-yl)methanol, (2-phenyl-1H-imidazole-4,5-diyl)dimethanol, 1,3-dialkyl-1H-imidazol-3-ium salts, 2,6-di-tert-butyl-4-dimethylaminomethylphenol and/or (1-methylimidazolium)zinc(II) acetylacetonate.

Point 8: Hardener system according to one or more of points 1 to 7, wherein the aromatic dianhydride compound A used has a mean particle size of less than 100 μm, determined to DIN EN ISO 8130-13.

Point 9: Use of hardener systems according to one or more of points 1 to 8 for hardening of epoxy resin systems.

Point 10: Epoxy resin system comprising at least one epoxy resin and at least one hardener system according to one or more of points 1 to 8.

Point 11: Epoxy resin system according to point 10, wherein it does not comprise any solvent.

Point 12: Epoxy resin system according to point 10 or 11, wherein 0.3-1 mol of anhydride groups is used per mole of epoxy group present in the epoxy resin used.

Point 13: Epoxy resin system according to one or more of points 10 to 12, wherein no aminic epoxy resins are present.

Point 14: Process for hardening epoxy resin systems, wherein a mixture of at least one aromatic dianhydride compound A having a melting point of at least 35° C. and at least one monoanhydride compound B having a melting point of not more than 30° C. is mixed with at least one epoxy resin in a first step, the aromatic dianhydride compound A being dispersed in the monoanhydride compound B, at least one catalyst C is added in a second step and then the at least one epoxy resin is cured at a temperature of at least 25° C.

Point 15: Process for hardening epoxy resin systems, wherein a mixture of at least one aromatic dianhydride compound A having a melting point of at least 35° C., at least one monoanhydride compound B having a melting point of not more than 30° C. and at least one catalyst C, the aromatic dianhydride compound A being dispersed in the hardener system, is mixed with at least one epoxy resin in a first step and then the at least one epoxy resin is cured at a temperature of at least 25° C.

Point 16: Process according to point 14 or 15, wherein the hardening is effected at a temperature below the melting temperature of the aromatic dianhydride compound A.

The examples which now follow describe preferred embodiments of the present invention and should not be understood in such a way that they restrict the present invention in any way. Having generally described this invention, a further understanding can be obtained by reference to certain specific examples which are provided herein for purposes of illustration only, and are not intended to be limiting unless otherwise specified.

### EXAMPLES

### General Remarks

Chemicals

In the examples which follow, trade names are used, and these have the following meanings:

“Lindride 32” means MTHPA.

“Lindride 52 D” means MHHPSA.

“Celloxide 2021P” means 7-oxabicyclo[4.1.0]heptan-3-ylmethyl 7-oxabicyclo[4.1.0]heptane-3-carboxylate and has the following structure:

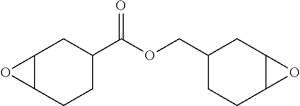 [SMILES: O=C(OCC1CCC2OC2C1)C1CCC2OC2C1]

“EPIKOTE Resin 883” means an epoxy resin composed of a bisphenol F epichlorohydrin resin (50-70%), a bisphenol A epichlorohydrin resin (25-35%) and of propylene glycol (12.5-15%).

“Epicure Catalyst 100” is 1-methyl-1H-imidazole and has the following structure:

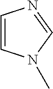

“Epicure Curing Agent 868” is N,N-dimethyl-1-phenylmethanamine and has the following: structure:

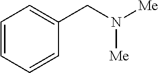

“Araldite 506” means an epoxy resin composed of a bisphenol A epichlorohydrin resin and a further epoxy resin.

“Epilox P13-30” is 2,2′-(((2-ethyl-2-((oxiran-2-ylmethoxy)methyl)propane-1,3-diyl)bis(oxy))bis(methylene))bis(oxirane) and has the following structure:

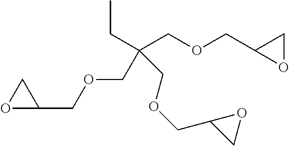 [SMILES: CCC(COCC1CO1)(COCC1CO1)COCC1CO1]

“Epilox A18-00” is 2,2′-(((propane-2,2-diylbis(4,1-phenylene))bis(oxy))bis(methylene))bis(oxirane) and has the following structure:

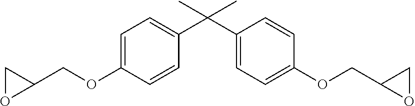 [SMILES: CC(C)(c1ccc(OCC2CO2)cc1)c1ccc(OCC2CO2)cc1]

“Araldit CY 5948” means an epoxy resin composed of a bisphenol A/F epichlorohydrin resin (60-100%) and of polyethylene glycol 200-600 (7-13%).

“EPIKOTE Resin 166” means an epoxy resin composed of a bisphenol F epichlorohydrin resin and a bisphenol A epichlorohydrin resin.

“Bisphenol F” is 4,4′-methylenediphenol and has the following structure:

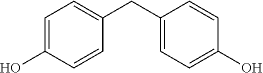 [SMILES: Oc1ccc(Cc2ccc(O)cc2)cc1]

“Bisphenol A” is 4,4′-(propane-2,2-diyl)diphenol and has the following structure:

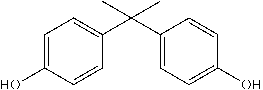 [SMILES: CC(C)(c1ccc(O)cc1)c1ccc(O)cc1]

The processing temperature is ideally 0-30° C.

The test specimens were produced by filling aluminium crucibles with about 10 g of material, followed by hardening in an oven. The test specimens thus obtained were disc-shaped with a diameter of about 5.0 cm and a thickness of about 0.5 cm.

The following hardening temperature profiles were used:

Hardening programme 1: Heating the mixture to 70° C. for 4 h.

Hardening programme 2: Heating the mixture to 70° C. for 4 h and to 130° C. for a further 10 h.

Hardening programme 3: Heating the mixture to 70° C. for 5 h, to 130° C. for 10 h, to 150° C. for 5 h, to 180° C. for 5 h and to 200° C. for a further 5 h.

Hardening programme 4: Heating the mixture to 180° C. for 2 h.

DSC analyses: The analyses were conducted in a Netzsch DSC 200 F3 Maia instrument to DIN EN ISO 11357. In a departure from this, the heating rate was 10 K/min.

### Example 1

### According to the Present Invention

MNA (15 g) and Lindride 52 D from Lindau (805 g) were initially charged. Thereafter, s-BTDA (180 g) was added. The components were mixed vigorously with N,N-dimethyl-1-benzylamine (5 g). The mixture thus obtained was blended with Celloxide 2021P from Daicel (1000 g). Test specimens produced according to hardening programme 1 were dimensionally stable, clear and free of solid particles. If hardening programme 3 was used, a material having a glass transition temperature of 210° C. was obtained.

### Example 2

### According to the Present Invention

MNA (0.3 g) and Lindride 52 D from Lindau (16 g) were initially charged. Thereafter, s-BTDA (4 g) was added and the mixture was mixed vigorously. The mixture thus obtained was blended with EPIKOTE® Resin 883 from Momentive (20 g) together with Epicure™ Catalyst 100 from Hexion (0.1 g). Test specimens produced according to hardening programme 2 were dimensionally stable, and a material having a glass transition temperature of 103° C. was obtained.

### Example 3

### According to the Present Invention

MNA (15 g) and Lindride 52 D from Lindau (805 g) were initially charged. Thereafter, s-BTDA (180 g) was added. The components were mixed vigorously together with Ionol® 103 (5 g). The mixture thus obtained was blended with Celloxide 2021P from Daicel (1000 g). If hardening programme 2 was used, a material having a glass transition temperature of 183° C. was obtained.

### Example 4

### According to the Present Invention

MNA (2 g) and Epicure™ Curing Agent 868 from Hexion (15 g) were initially charged. Thereafter, s-BTDA (20 g) was added. The components were mixed vigorously together with Epicure™ Catalyst 100 from Hexion (0.4 g). The mixture thus obtained was blended with Celloxide 2021P from Daicel (42 g). Test specimens produced according to hardening programme 4 gave a material having a glass transition temperature of 194° C.

### Example 5

### According to the Present Invention

MNA (0.6 g) and Epicure™ Curing Agent 868 from Hexion (30 g) were initially charged. Thereafter, s-BTDA (7 g) was added. The components were mixed vigorously together with Epicure™ Catalyst 100 from Hexion (0.2 g). The mixture thus obtained was blended with Celloxide 2021P from Daicel (36 g). Test specimens produced according to hardening programme 1 were dimensionally stable, clear and free of solid particles. If hardening programme 2 was used, a material having a glass transition temperature of 220° C. was obtained.

### Example 6

### According to the Present Invention

MNA (15 g) and Lindride 52 D from Lindau (805 g) were initially charged.

Thereafter, s-BTDA (180 g) was added together with (1MZ)Zn(acac)₂ (5 g) and the mixture was mixed vigorously. The mixture thus obtained was blended with Celloxide 2021P from Daicel (1000 g). Test specimens produced according to hardening programme 2 were dimensionally stable, clear and free of solid particles, and had a glass transition temperature of 182° C.

### Example 7

### According to the Present Invention

MNA (3 g) and s-BTDA (26 g) were initially charged. The two components were mixed vigorously together with Epicure™ Catalyst 100 from Hexion (0.2 g). The mixture thus obtained was blended with Araldite® 506 from Huntsman (50 g). Test specimens produced according to hardening programme 1 were dimensionally stable, clear and free of solid particles. If hardening programme 4 was used, a material having a glass transition temperature of 228° C. was obtained.

### Example 8

### According to the Present Invention

s-BTDA (25 g), Epicure™ Catalyst 100 from Hexion (0.9 g), Lindride 52 D from Lindau (136 g) and Celloxide 2021P from Daicel (162 g) were blended. Test specimens produced according to hardening programme 1 were dimensionally stable and yellow. If hardening programme 2 was used, a material having a glass transition temperature of 242° C. was obtained.

### Example 9

### According to the Present Invention

MNA (3 g) and Lindride 52 D from Lindau (160 g) were initially charged. Thereafter, s-BTDA (36 g) was added. The components were homogenized together with Epicure™ Catalyst 100 from Hexion (1 g). The mixture thus obtained was blended with 2-phenyloxirane (194 g). Test specimens produced according to hardening programme 4 were dimensionally stable, and a material having a glass transition temperature of 253° C. was obtained.

### Example 10

### According to the Present Invention

Epicure™ Curing Agent 868 from Hexion (36 g), MNA (1 g) and s-BTDA (8 g) were initially charged. The components were mixed vigorously together with Epicure™ Catalyst 100 from Hexion (0.5 g). The mixture thus obtained was blended with Celloxide 2021P from Daicel (38 g). Test specimens produced according to hardening programme 2 were dimensionally stable, clear and free of solid particles. The obtained material had a glass transition temperature of 201° C.

### Example 11

### According to the Present Invention

Lindride 52 D from Lindau (20 g) and MNA (0.4 g) were initially charged. Thereafter, s-BTDA (4.5 g) was added. The anhydrides were mixed vigorously together with Epicure™ Catalyst 100 from Hexion (0.2 g). The mixture thus obtained was blended with 2-butyloxirane (21 g). Test specimens produced according to hardening programme 2 were dimensionally stable, and a material having a glass transition temperature of 131° C. was obtained.

### Example 12

### According to the Present Invention

MNA (1 g) and Lindride 52 D from Lindau (54 g) were initially charged. Thereafter, s-BTDA (12 g) was added. The components were mixed vigorously together with Epicure™ Catalyst 100 from Hexion (0.4 g). The mixture thus obtained was blended with Epilox® P13-30 (82 g). Test specimens produced according to hardening programme 2 were dimensionally stable, and a material having a glass transition temperature of 71° C. was obtained.

### Example 13

### According to the Present Invention

MNA (1 g) and Lindride 52 D from Lindau (54 g) were initially charged. Thereafter, s-BTDA (12 g) was added. The components were mixed vigorously together with Epicure™ Catalyst 100 from Hexion (0.4 g). The mixture thus obtained was blended with Epilox® A18-00 (68 g). Test specimens produced according to hardening programme 2 were dimensionally stable, and a material having a glass transition temperature of 144° C. was obtained.

### Example 14

### According to the Present Invention

MNA (15 g) and Lindride 52 D from Lindau (805 g) were initially charged. Thereafter, s-BTDA (180 g) was added. The components were then mixed vigorously with 2P4MHZ (5 g). The mixture thus obtained was blended with Celloxide 2021P from Daicel (1000 g). Test specimens produced according to hardening programme 1 were dimensionally stable, clear and free of solid particles. If hardening programme 2 was used, a material having a glass transition temperature of 222° C. was obtained. If hardening programme 3 was used, a material having a glass transition temperature of 205° C. was obtained.

### Example 15

### According to the Present Invention

Lindride 52 D from Lindau (86 g) and MNA (2 g) were initially charged. Thereafter, s-BTDA (20 g) was added. The anhydrides were mixed vigorously together with Epicure™ Catalyst 100 from Hexion (0.5 g). The mixture thus obtained was blended with Araldit CY 5948 from Huntsman (110 g). Test specimens produced according to hardening programme 2 were dimensionally stable, and a material having a glass transition temperature of 111° C. was obtained.

### Example 16

### According to the Present Invention

Epicure™ Curing Agent 868 from Hexion (30 g), MNA (1 g) and s-BTDA (7 g) were initially charged. The components were mixed vigorously together with Epicure™ Catalyst 100 from Hexion (0.1 g). The mixture thus obtained was blended with Celloxide 2021P from Daicel (47 g). Test specimens produced according to hardening programme 1 were dimensionally stable, clear and free of solid particles. If hardening programme 2 was used, a material having a glass transition temperature of 200° C. was obtained.

### Example 17

### According to the Present Invention

Epicure™ Curing Agent 868 from Hexion (23 g), MNA (1 g) and s-BTDA (14 g) were initially charged. The components were mixed vigorously together with Epicure™ Catalyst 100 from Hexion (0.4 g). The mixture thus obtained was blended with Epicote™ Resin 166 from Hexion (49 g). Test specimens produced according to hardening programme 1 were dimensionally stable, clear and free of solid particles. The obtained material had a glass transition temperature of 145° C.

### Example 18

### According to the Present Invention

Epicure™ Curing Agent 868 from Hexion (15 g), MNA (2 g) and s-BTDA (20 g) were initially charged. The components were mixed vigorously together with Epicure™ Catalyst 100 from Hexion (0.4 g). The mixture thus obtained was blended with Epicote™ Resin 166 from Hexion (42 g). Test specimens produced according to hardening programme 2 were dimensionally stable, clear and free of solid particles. The obtained material had a glass transition temperature of 184° C.

### Example 19

### According to the Present Invention

MNA (1 g), Epicure™ Curing Agent 868 from Hexion (36 g) and s-BTDA (8 g) were initially charged. The components were mixed vigorously together with Epicure™ Catalyst 100 from Hexion (0.5 g). The mixture thus obtained was blended with Celloxide 2021P from Daicel (38 g). Test specimens produced according to hardening programme 4 gave a material having a glass transition temperature of 212° C.

### Example 20

### According to the Present Invention

s-BTDA (25 g), Epicure™ Catalyst 100 from Hexion (0.9 g), MNA (144 g) and Celloxide 2021P from Daicel (162 g) were blended. Test specimens produced according to hardening programme 1 were dimensionally stable and yellow. If hardening programme 2 was used, a material having a glass transition temperature of 248° C. was obtained.

### Example 21

### According to the Present Invention

To test the heat stability, the material from Example 1 was subjected to a storage test. After 480 h at 204° C., the material showed a loss of mass of 1%.

### Example 22

### Not According to the Present Invention

Maleic anhydride (74 g), Epicure™ Catalyst 100 from Hexion (0.9 g) and Celloxide 2021P from Daicel (162 g) were blended. The mixture reacted with significant exothermicity. No glass transition temperature of the resulting material could be determined.

### Example 23

### Not According to the Present Invention

s-BTDA (121 g), Epicure™ Catalyst 100 from Hexion (0.9 g) and Celloxide 2021P from Daicel (162 g) were blended. The mixture reacted with significant exothermicity. No glass transition temperature of the resulting material could be determined.

### Example 24

### Not According to the Present Invention

MNA (106 g), Epicure™ Catalyst 100 from Hexion (0.5 g) and Celloxide 2021P from Daicel (100 g) were blended. After 4 h at 70° C. in an oven, the material was not dimensionally stable and was therefore not used any further.

### Example 25

### According to the Present Invention

Lindride 32 (MTHPA) from Lindau (20 g) was initially charged. Thereafter, s-BTDA (5 g) was added. The components were mixed vigorously together with Epicure™ Catalyst 100 from Hexion (0.1 g). The mixture thus obtained was blended with Celloxide 2021P from Daicel (25 g). Test specimens produced according to hardening programme 2 were dimensionally stable, and a material having a glass transition temperature of 245° C. was obtained.

Even without further details, it is assumed that a person skilled in the art can utilize the above description to the widest possible extent. The preferred embodiments and examples should therefore be interpreted merely as descriptive disclosure which is not limiting in any way whatsoever.

1. A composition, comprising:
i) an aromatic dianhydride compound A having a melting point of at least 35° C.;
ii) a monoanhydride compound B having a melting point of not more than 30° C.; and
iii) a catalyst C;
wherein
the aromatic dianhydride compound A is dispersed in the composition, and
the composition is a hardener system for an epoxy resin.

2. The composition according to claim 1, wherein the aromatic dianhydride compound A is selected from the group consisting of benzo[1,2-c:4,5-c′]difuran-1,3,5,7-tetraone, [4,4′-biisobenzofuran]-1,1′,3,3′-tetraone, [4,5′-biisobenzofuran]-1,1′,3,3′-tetraone, 5,5′(perfluoropropane-2,2-diyl)bis(isobenzofuran-1,3-dione), 5,5′ carbonylbis(isobenzofuran-1,3-dione), 4-(1,3-dioxo-1,3-dihydroisobenzofuran-5-carbonyl)isobenzofuran-1,3-dione, 5,5′-oxybis(isobenzofuran-1,3-dione), 5,5′ sulphonylbis(isobenzofuran-1,3-dione), isochromeno[6,5,4-def]isochromene-1,3,6,8-tetraone and a substituted derivative thereof.

3. The composition according to claim 1, wherein the aromatic dianhydride compound A is at least one of 5,5′-carbonylbis(isobenzofuran-1,3-dione), and benzo[1,2-c:4,5-c′]difuran-1,3,5,7-tetraone.

4. The composition according to claim 1, wherein the monoanhydride compound B is selected from the group consisting of cyclic anhydrides of aromatic, aliphatic, cycloaliphatic and heterocyclic polycarboxylic acids.

5. The composition according to claim 1, wherein the monoanhydride compound B is selected from the group consisting of methylhexahydroisobenzofuran-1,3-dione, 5-methyl-3a,4,7,7a-tetrahydro-4,7-methanoisobenzofuran-1,3-dione, 5-methyl-3a,4,7,7a-tetrahydroisobenzofuran-1,3-dione, 3-methylfuran-2,5-dione, 3,3,4,4,5,5-hexafluorodihydro-2H-pyran-2,6(3H)-dione and 3,3-dimethyldihydrofuran-2,5-dione.

6. The composition according to claim 1, wherein the catalyst C is selected from the group consisting of amines, cycloaliphatic N-heterocycles, aromatic N-heterocycles, phenolic amines and metal salts.

7. The composition according to claim 6, wherein the catalyst C is selected from the group consisting of N,N-dimethyl-1-benzylamine, N1,N1-dimethyl-N3-(2,2,6,6-tetramethylpiperidin-4-yl)propane-1,3-diamine, 1,2,2,6,6-pentamethylpiperidin-4-ol, 2 ethyl-4-methyl-1H-imidazole, 1-methyl-1H-imidazole, 2-phenyl-1H-imidazole, (4-methyl-2-phenyl-1H-imidazol-5-yl)methanol, (2-phenyl-1H-imidazole-4,5-diyl)dimethanol, 1,3-dialkyl-1H-imidazol-3-ium salts, 2,6-di-tert-butyl-4-dimethylaminomethylphenol and (1-methylimidazolium)zinc(II) acetylacetonate.

8. The composition according to claim 1, wherein a mean particle size of the aromatic dianhydride compound A is less than 100 μm, determined according to DIN EN ISO 8130-13.

9. An epoxy resin system comprising:
an epoxy resin: and
a composition according to claim 1.

10. The epoxy resin system according to claim 9, wherein the system is free of solvent.

11. The epoxy resin system according to claim 9, comprising 0.3-1 mol of anhydride groups per mole of epoxy group present in the epoxy resin used.

12. The epoxy resin system according to claim 9, wherein the epoxy resin system is free of aminic epoxy resins.

13. A process to harden an epoxy resin system, comprising:
mixing the composition according to claim 1 with the epoxy resin system; and
curing the mixture at a temperature of at least 25° C. to obtain a hardened epoxy resin.

14. The process for hardening an epoxy resin system according to claim 13, wherein
the mixing comprises first preparing a mixture of the aromatic dianhydride compound A and the monoanhydride compound B with the one epoxy resin, and then
adding the catalyst C to the mixture.

15. The process for hardening an epoxy resin system according to claim 13, wherein the curing temperature is less than a melting temperature of the aromatic dianhydride compound A.
